(19) United States
(12) Patent Application Publication
(10) Pub. No.: US 2024/0178412 A1
(43) Pub. Date: May 30, 2024

(54) SEPARATOR PLATE HAVING A HOLDING STRUCTURE FOR A CONNECTOR PIN

(71) Applicant: Reinz-Dichtungs-GmbH, Neu-Ulm (DE)

(72) Inventors: Bernadette GRUENWALD, Ulm (DE); Claudia KUNZ, Ulm (DE); Tim DANIEL, Ulm (DE)

(21) Appl. No.: 18/520,300

(22) Filed: Nov. 27, 2023

(30) Foreign Application Priority Data
Nov. 28, 2022 (DE) 20 2022 106 651.5

(51) Int. Cl. H01M 8/0271; C25B 9/23; C25B 13/02; H01M 8/0247; H01M 8/0258; H01M 8/1004

(52) U.S. Cl. CPC H01M 8/0271; C25B 9/23; C25B 13/02; H01M 8/0247; H01M 8/0258; H01M 8/1004

(57) ABSTRACT

A separator plate for an electrochemical system. The separator plate comprising a first individual plate, a second individual plate, and a holding structure. The individual plates are spaced apart from each other in the region of the holding structure, so that the connector pin can be inserted into the holding structure. The holding structure has a clamping region and a receiving region. The clamping region can clamp the connector pin between its individual plates. The receiving region starts from the outer edge and is arranged upstream of the clamping region in the direction of insertion. At least in a non-compressed state of the separator plate, at least the first individual plate extends in a concave manner along the direction of insertion in the receiving region, so that an edge of the first individual plate is directed towards the separator plate plane in the receiving region.

### CROSS-REFERENCE TO RELATED APPLICATION

The present application claims priority to German Utility Model Application No. 20 2022 106 651.5, entitled “SEPARATOR PLATE HAVING A HOLDING STRUCTURE FOR A CONNECTOR PIN”, and filed on Nov. 28, 2022. The entire contents of the above-listed application is hereby incorporated by reference for all purposes.

### TECHNICAL FIELD

The present disclosure relates to a separator plate for an electrochemical system, having a holding structure for holding a connector pin.

### BACKGROUND AND SUMMARY

The separator plate may for example be used for a fuel cell system, in which electrical energy is produced from hydrogen and oxygen. The separator plate may also be used for an electrolyzer, in which hydrogen and oxygen are produced from water by applying a potential. The separator plate may also be used for an electrochemical compressor, in which, by applying a potential, molecular hydrogen is transported through the membrane by oxidation/reduction and at the same time is compressed. The separator plate may also be used for a redox flow battery, in which two energy-storing electrolytes are conducted in two separate circuits, between which ions are exchanged through a membrane. The electrochemical system according to the present disclosure may therefore comprise one of the aforementioned electrochemical systems.

In a first variant, separator plates for an electrochemical system comprise a pair of plates comprising two metal individual plates, wherein in each case two separator plates bound an electrochemical cell, e.g. a fuel cell. In the narrower sense, one individual plate belongs to one cell and the other individual plate of the separator plate already belongs to the next cell. In an electrochemical system, usually a plurality of electrochemical cells, for example up to 600, are stacked in series to form a stack. The cells themselves usually each comprise, in addition to two half separator plates, a membrane electrode assembly, also referred to as an MEA, which is arranged between the separator plates, as well as a gas diffusion layer (GDL), which consists for example of electrically conductive carbon fleece, on each side of the MEA. The entire stack is held together between two end plates by means of a clamping system and is compressed to a predetermined extent.

Besides bounding the electrochemical cells, the separator plates have a number of other functions in an electrochemical system, namely on the one hand electrically contacting the electrodes of the various electrochemical cells and transmitting the current to the respectively adjacent cell, and on the other hand supplying reaction media to the cells and removing the reaction products, as well as cooling the electrochemical cells and discharging the waste heat, and also sealing off the compartments of the two different reaction media and the coolant with respect to each other and with respect to the outside.

In the two metal individual plates of the separator plate through-openings are formed for supplying the electrochemical cells with reaction media, e.g. usually on the one hand hydrogen or methanol and on the other hand air or oxygen, as well as coolants, usually mixtures of demineralized water and antifreeze. In addition, a distribution structure is integrally formed in each of the two metal individual plates, wherein channels are formed on both surfaces of the two individual plates. A reaction medium is guided on each of the outward-facing surfaces of the separator plate, and the coolant is guided in the intermediate space between the two metal individual plates. The region which, in an orthogonal projection into a common plane containing the MEA, coincides with the actual membrane and not with the border region thereof or its sealing structure is also referred to as the electrochemically active region of the separator plate. In this electrochemically active region of the separator plate, a reaction medium is guided in a channel structure on the surface of the separator plate that faces towards the MEA. Usually, two sides of the electrochemically active region are adjoined by a distribution region which likewise has channel-like distribution structures. Each of the distribution structures communicates with at least two of the through-openings, namely at least one inlet and at least one outlet for the respective fluid. In each of the metal individual plates, a sealing structure is arranged at least in a circumferentially closed manner around the electrochemically active region of the separator plate and optionally around at least some of the through-openings in order to seal these off with respect to the outside, said sealing structure being spaced apart from the electrochemically active region and the edge of the through-opening in question. In addition, individual through-openings may also be sealed off by a sealing structure that extends in an intrinsically closed manner around the respective through-opening, in order to seal these off with respect to each other.

In a second variant, separator plates may comprise just one individual plate, in which structures for guiding reaction media are formed on both surfaces. This variant is often used, for example, in polymer electrolyte electrolyzers (PEM-EL), which do not include a cooling mechanism.

In order to check whether the electrochemical cells are delivering a sufficient cell voltage (cell voltage measurement, CVM), the individual cells are electrically contacted at the edge of the separator plates. This contacting must be mechanically stable and vibration-proof in order to be able to check the cell voltage even during ongoing operation, for example when used in a vehicle.

Embossed holding structures at the outer edge of the separator plate are often used to receive and clamp the connector pins. When the separator plates are compressed with an MEA to form a stack, it may happen that the MEA is damaged by the embossed holding structures, for example by the edge of the separator plate in the region of the embossed structures. It may also happen that the MEA is damaged during the insertion of the connector pin into the holding structure.

It is therefore an object of the present disclosure to provide a separator plate for an electrochemical system and an assembly for an electrochemical system, which on the one hand enable reliable electrical contacting and secure holding of the connector pin and on the other hand cause no damage, or very little damage, to the membrane electrode assembly even in a compressed state.

This object is achieved by the subjects of the independent claims. Developments may be described by the subjects of the dependent claims and in the description below.

A separator plate according to the present disclosure for an electrochemical system has a separator plate plane and comprises a first individual plate and a second individual plate, wherein the first individual plate and the second individual plate are connected to each other and form at an outer edge of the separator plate a holding structure for holding a connector pin. The individual plates are spaced apart from each other in the region of the holding structure, so that the connector pin can be inserted into the holding structure along a direction of insertion. The holding structure has a clamping region and a receiving region, wherein in the clamping region the connector pin can be clamped between the individual plates. The receiving region starts from the outer edge and is arranged upstream of the clamping region in the direction of insertion. At least in a non-compressed state of the separator plate, at least the first individual plate extends in a concave manner along the direction of insertion in the receiving region, such as in an arcuate or angled manner, so that an edge of the first individual plate is directed towards the separator plate plane in the receiving region.

The individual plates of the separator plate often have small material thicknesses of 100 μm or even less, so that they can easily be bent. Due to this material thickness, the individual plates often have sharp outer edges, which may potentially damage a membrane electrode assembly or other adjacent structures that bear against the separator plate. By virtue of the fact that the edge or the free end of the first individual plate is directed towards the separator plate plane, it is possible to prevent the individual plate from coming into contact with adjacent structures in the region of its edge during compression. This reduces the likelihood that these structures, such as the aforementioned membrane electrode assembly, will be damaged or even rendered unusable.

The concave curvature in the receiving region provides a certain springiness of the receiving region, for example when stacking separator plates and membrane electrode assemblies—usually in an alternating manner—and when compressing the separator plate, for example when clamping the stack prior to putting the electrochemical system into operation, as a result of which it is possible to prevent the edge from contacting or damaging the adjacent membrane electrode assembly.

In the context of this specification, the edge of an individual plate is to be understood as a material edge. Imagining that the course of the individual plate were to be continued beyond the edge, the course would thus typically intersect the separator plate plane. The fact that the edge of the first individual plate is directed towards the separator plate plane may also mean that the concave curvature of the receiving region, which is arranged immediately downstream of the edge in the direction of insertion, is at a greater distance perpendicular to the separator plate plane than the edge itself.

Here, clampable may mean that the connector pin is contacted by both individual plates and is held in the holding structure at least in a force-fitting manner, such as in a mechanically stable and vibration-proof manner. The clamping region often has a cross-section that corresponds to a cross-section of the connector pin in order to enable a secure fit of the connector pin in the receptacle. For instance, the clamping region may have a square, rectangular, hexagonal or honeycomb-shaped cross-section, it being possible for corners of these cross-sectional shapes to be pointed or rounded. The cross-section of the clamping region and the cross-section of the connector pin to be received may be dimensioned in relation to each other in such a way that there is no excessive play between the clamping region and the connector pin to be received, while at the same time enabling insertion without great effort. The connector pin is actually fixed in place by a bearing of the connector pin in the clamping region, so that the clamping region and the connector pin bear against each other in a force-fitting and/or form-fitting manner.

In some embodiments of the separator plate, at least in a non-compressed state of the separator plate, the second individual plate, in addition to the first individual plate, may also extend in a concave manner along the direction of insertion in the receiving region, such as in an arcuate or angled manner, so that an edge of the second individual plate is directed towards the separator plate plane in the receiving region. Optionally, embodiments are possible in which the receiving region or the entire holding structure is mirror-symmetrical, wherein the separator plate plane or a plane extending parallel to the separator plate plane serves for example as the mirror plane. In some embodiments, it may be provided that the second individual plate is designed differently in the receiving region than the first individual plate in the receiving region, so that the second individual plate has, for example, a different curvature in the receiving region than the first individual plate in the receiving region or is shorter or longer along the direction of insertion.

In other embodiments of the separator plate, it may be provided that the individual plates are spaced further apart from each other, in a direction perpendicular to the separator plate plane, in the receiving region than in the clamping region. This may facilitate insertion of the connector pin along the direction of insertion and contributes to the desired spring behavior in the receiving region.

In some embodiments of the separator plate, it may be provided that a ratio between a maximum width of the receiving region and a maximum width of the clamping region is greater than 1, greater than 1.5, or greater than 2, wherein a width direction or transverse direction is defined perpendicular to the direction of insertion and parallel to the separator plate plane. The direction of insertion may define a longitudinal direction. Optionally, the above-mentioned ratio may be between 3 and 5, also between 3 and 4. In these embodiments, the receiving region is therefore wider than the clamping region of the holding structure. This can also facilitate insertion of the connector pin. Furthermore, this design of the receiving region can influence the elasticity or the spring effect of the separator plate, such as when compressing the separator plate in a plate stack of an electrochemical system. The spring effect of the receiving region can thus be adjusted by the width of the receiving region, with a wider receiving region being characterized by a softer spring constant.

Furthermore, embodiments are possible in which the receiving region has a transition portion which adjoins the clamping region and in which the receiving region tapers, so that the receiving region merges into the clamping region. In a first portion of the receiving region, which is upstream of the transition portion in the direction of insertion, a width of the receiving region may be constant. For example, in an orthogonal projection of the first individual plate onto the separator plate plane, the receiving region has at least in part a substantially rectangular outline. Alternatively, in an orthogonal projection of the first individual plate onto the separator plate plane, the receiving region may have at least in part a substantially funnel-shaped or trapezoidal outline.

In some embodiments, the separator plate may be designed in such a way that, in an orthogonal projection of the first individual plate onto the separator plate plane, the clamping region has at least in part a substantially rectangular outline. The clamping region may have an end portion which delimits the clamping region in the direction of insertion on the side located opposite the receiving region. In an orthogonal projection of the first individual plate onto the separator plate plane, the end portion may have a semicircular or rounded shape. When the extent of the clamping region along the direction of insertion is mentioned below, this means the extent or the length of the clamping region without the end portion.

In some embodiments of the separator plate, the direction of insertion extends substantially perpendicular to a course of the outer edge in the region of the holding structure. Here, substantially perpendicular may mean that an angle that the direction of insertion encloses with the outer edge differs from 90° by less than 30°, or less than 15º or less than 5º. The outer edge, for instance a projection of the outer edge onto the separator plate plane, usually has a rectilinear course in the region of the holding structure, but in some embodiments, it may have a slightly curved or arcuate course.

It may be provided that a ratio between the maximum extent of the clamping region in the direction of insertion and the maximum extent of the clamping region in a direction perpendicular to the direction of insertion and parallel to the separator plate plane is greater than 1, greater than 2, or greater than 3. In this case, therefore, the clamping region is longer than it is wide.

Optionally, a ratio between the maximum extent of the receiving region in the direction of insertion and the maximum extent of the receiving region in a direction perpendicular to the direction of insertion and parallel to the separator plate plane is less than 1, less than 0.8, or less than 0.5. In this case, therefore, the receiving region is wider than it is long.

It may be provided that a ratio between the maximum extent of the clamping region in the direction of insertion and the maximum extent of the receiving region in the direction of insertion is greater than 1, greater than 2, or greater than 3. The clamping region is thus often longer than the receiving region.

It may be provided that the holding structure has a top in the receiving region, wherein surface lines that extend perpendicular to the direction of insertion on the top extend in a rectilinear manner and/or parallel to the separator plate plane. As a result, a bearing area of the MEA against the receiving region may be increased, thereby reducing the local pressure load on the MEA.

In other embodiments of the separator plate, it may be provided that the individual plates come into contact with each other on both sides of the holding structure and along the outer edge. In portions further away from the holding structure, the individual plates may diverge in the region of the outer edge of the separator plate, cf. for example the publication DE 20 2020 106 144 U1, which is hereby fully incorporated in the present disclosure by way of reference.

Furthermore, it may be provided that the individual plates form at least one further holding structure for holding a connector pin. In this case, the directions of insertion of at least two holding structures may extend substantially parallel to each other. Deviations from parallelism are possible, wherein an angle enclosed by the two directions of insertion may in this case be up to 90° or up to 30°.

In embodiments of the separator plate having more than one holding structure, the separator plate may have an embossed structure, such as a supporting structure and/or a connecting structure, which connects at least two holding structures to each other. For instance, the separator plate, or at least one of the two individual plates, may have a supporting structure which extends at a distance from the outer edge and connects at least two holding structures to each other. For example, the supporting structure may connect the clamping regions of the two holding structures to each other. The supporting structure may extend parallel to the outer edge of the separator plate. For instance, a cross-section of a supporting structure may substantially correspond to the cross-section of a holding structure in the clamping region. The two individual plates may be spaced apart by a constant distance in the region of the supporting structure between the two holding structures. As an alternative or in addition, receiving regions of at least two holding structures may merge into each other along the outer edge or directly at the outer edge by means of a connecting structure. By connecting the two receiving regions, this results in a combined receiving region with two downstream clamping regions for the respective holding structures. The connecting structure therefore ensures a significant spread of the respective receiving regions and may help to further improve the spring behavior in the front part of the combined receiving region. The two individual plates may be spaced apart by a constant distance in the region of the connecting structure along the outer edge between the two holding structures. In this case, the edges of the two individual plates may extend parallel to each other and/or parallel to the separator plate plane in this region. At least in the non-compressed state of the separator plate, the connecting structure may continue the cross-section of the receiving region in a direction parallel to the outer edge in each or at least one individual plate. The edge of the first individual plate and/or the edge of the second individual plate may be directed towards the separator plate plane in the region of the connecting structure.

As already mentioned above, the separator plate may comprise two individual plates, which each have, on both surfaces, a guide structure for guiding reaction medium and/or coolant, for example in the form of channels at least in the active region. The individual plates may have substantially the same surface area, so that the outer edges thereof, in an orthogonal projection into the separator plate plane, coincide and/or extend closely adjacent to each other all the way around.

However, the separator plate may also comprise only a first individual plate, on which a respective guide structure for guiding reaction medium is formed on both surfaces. The extent of the separator plate may be largely determined by the surface area of the first individual plate, while a second individual plate is present only in at least or just one region of a holding structure. Such second individual plates of small size may be connected to the first individual plate in the region adjacent to a holding structure or at least partially surrounding the latter. In these cases, therefore, the second individual plate only has the function of closing off the holding structure, so that the connector pin can be held in the holding structure. The second individual plate may therefore have no fluid-guiding or fluid-sealing functions. The first individual plate may also have depressions, in which such a second individual plate of small size is received at least over part of its extent perpendicular to the plate plane. Otherwise, what has been stated above for the first and second individual plate applies. For instance, a voltage measuring pin may also be mounted in a separator plate that manages with just one layer for media guidance.

The individual plates may each be formed from a sheet, such as a sheet of metal. The holding structures may be formed in the respective individual plate by means of hydroforming, embossing and/or deep-drawing, for example. In this specification, the term embossing will be used as representative of hydroforming, embossing and deep-drawing. Together, the two individual plates form a separator plate and may for example be connected to each other by means of materially bonded joints, such as adhesive joints or soldered joints, for example welded joints.

The application also relates to an assembly for an electrochemical system, comprising a separator plate according to any one of the embodiments described above. The assembly also comprises a membrane electrode assembly, MEA, which is arranged parallel to the separator plate plane of the separator plate. The MEA comes into contact with the separator plate in the region of the holding structure, such as the top of the receiving region, wherein the edge of the first individual plate and the edge of the second individual plate are spaced apart from the MEA in the region of the holding structure in a compressed state of the assembly. The edges of the individual plates are therefore not in contact with the MEA in the region of the holding structure. This reduces the risk of the edges damaging the MEA. Other areas of the holding structure, such as areas of the receiving region, may come into contact with the MEA and thus support the latter.

A separator plate according to the present disclosure and an electrochemical system according to the present disclosure will be described in greater detail below with reference to figures. In doing so, various elements essential to the present disclosure or elements that further develop the present disclosure will be mentioned in the context of a specific example, but some of these elements can also be used to further develop the present disclosure when taken out of the context of the respective example and other features of the respective example. Furthermore, in the figures, identical or similar reference signs will be used for identical or similar elements, and the explanation thereof will therefore sometimes be omitted.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an electrochemical system according to the prior art, in a perspective view.

FIG. 2A shows part of a separator plate according to the prior art, in a plan view.

FIG. 2B shows a detail view of the separator plate of FIG. 2A.

FIG. 3A shows a perspective view of part of one embodiment of the separator plate.

FIG. 3B shows a sectional view of the separator plate of FIG. 3A along the section line A-A.

FIG. 3C shows a perspective detail view of the separator plate of FIG. 3A, sectioned along the section line A-A.

FIG. 3D shows a detailed view of part of the receiving region and of part of the clamping region of the separator plate of FIG. 3A.

FIG. 4 shows a sectional view of a holding structure according to a further embodiment of a separator plate.

FIG. 5 shows a sectional view of a holding structure according to a further embodiment of a separator plate.

FIG. 6 shows a sectional view of a holding structure according to a further embodiment of a separator plate.

FIG. 7 shows a sectional view of a holding structure according to a further embodiment of a separator plate.

FIG. 8 shows a sectional view of a holding structure according to a further embodiment of a separator plate.

FIG. 9 shows a sectional view of a holding structure according to a further embodiment of a separator plate.

FIG. 10A shows a perspective view of a further embodiment of the separator plate with two holding structures.

FIG. 10B shows another perspective view of the embodiment of the separator plate with two holding structures from FIG. 10A.

FIG. 11 shows a perspective view of a further embodiment of the separator plate with two holding structures which are connected to each other by way of a supporting structure.

FIG. 12 shows a sectional view of an assembly for an electrochemical system, comprising separator plates and membrane electrode assemblies.

FIG. 13 shows a sectional view of a further embodiment of an assembly for an electrochemical system.

FIGS. 14A and 14B show separator plates with different possible arrangements of holding structures.

### DETAILED DESCRIPTION

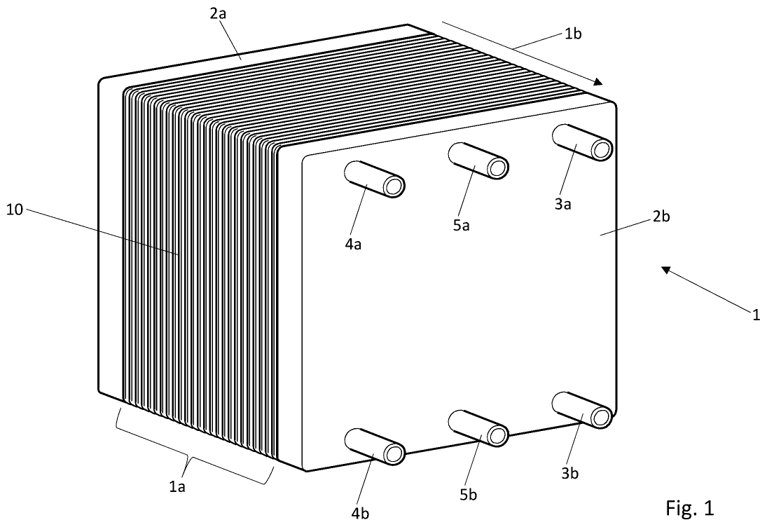

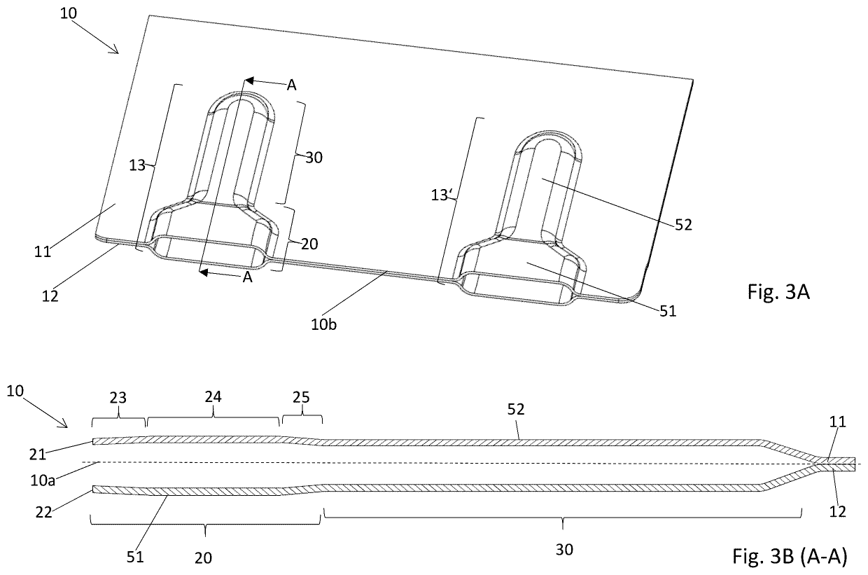

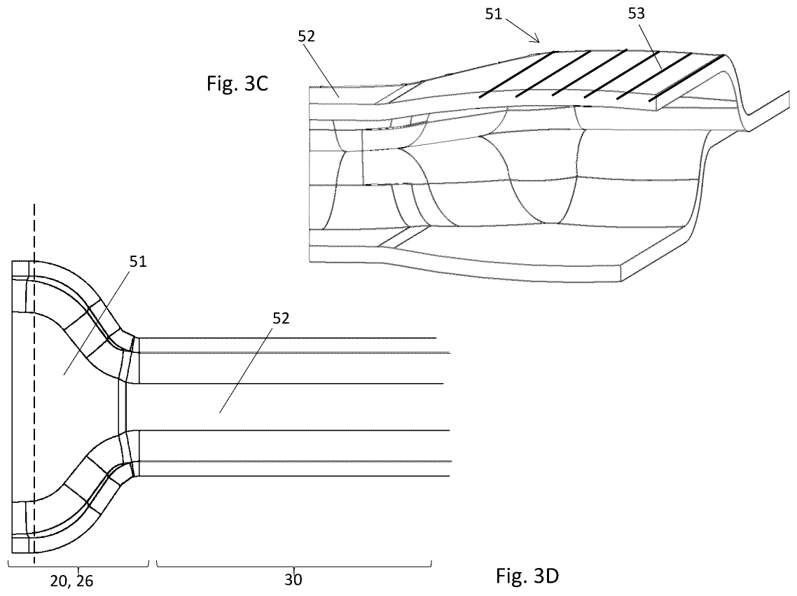

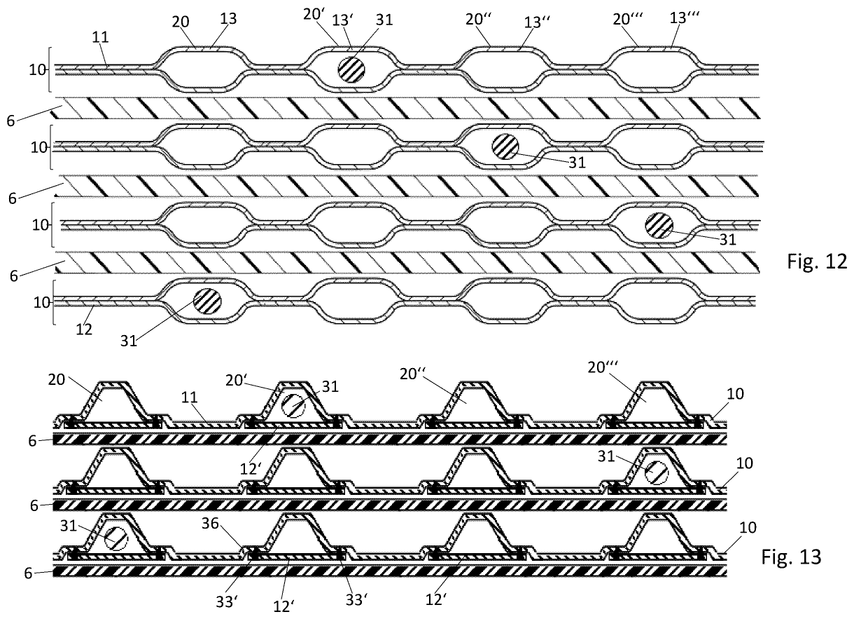

FIG. 1 shows an electrochemical system 1 according to the prior art, comprising a plurality of identical metal separator plates 10 which are arranged in a stack 1a and are stacked along a stacking direction 1b that extends perpendicular to a plate plane of the separator plates 10. The separator plates 10 of the stack 1a are clamped between two end plates 2a, 2b. As shown from FIG. 3A onwards, the separator plates 10 each comprise a first individual plate 11 and a second individual plate 12, which are connected to each other for example in a materially bonded manner. A plane in which a flat, non-deformed part of the first individual plate 11 comes into contact with a flat, non-deformed part of the second individual plate 12 when forming a separator plate 10 will hereinafter be referred to as the separator plate plane 10a of the separator plate 10. In the present example, the system 1 is a fuel cell stack. Each two adjacent separator plates 10 of the stack thus bound an electrochemical cell, which serves for example to convert chemical energy into electrical energy, or vice versa. Each individual plate of the separator plate forms part of a different cell. Each electrochemical cell usually comprises—as shown in FIGS. 12 and 13 for example—a membrane electrode assembly (MEA) 6, which has an electrically inactive frame in its outer region. Each MEA 6 typically contains at least one membrane, for example an electrolyte membrane. Furthermore, a gas diffusion layer (GDL) may be arranged on one or both surfaces of the MEA.

In alternative embodiments, the system 1 may also be designed as an electrolyzer, as an electrochemical compressor, or as a redox flow battery. Separator plates can likewise be used in these electrochemical systems, with these separator plates often being single-layered in the region of the flow field. The structure of these separator plates may then correspond to the structure of the separator plates 10 that are explained in detail here, although the media guided on and/or through the separator plates in the case of an electrolyzer, an electrochemical compressor or a redox flow battery may differ in each case from the media used for a fuel cell system.

The end plates 2a, 2b have a plurality of media ports 3a, 3b, 4a, 4b, 5a, 5b, via which media can be supplied to the system 1 and via which media can be discharged from the system 1. Said media that can be supplied to the system 1 and discharged from the system 1 may comprise for example fuels such as molecular hydrogen or methanol, reaction gases such as air or oxygen, reaction products such as water vapor or depleted fuels, or coolants such as water and/or glycol.

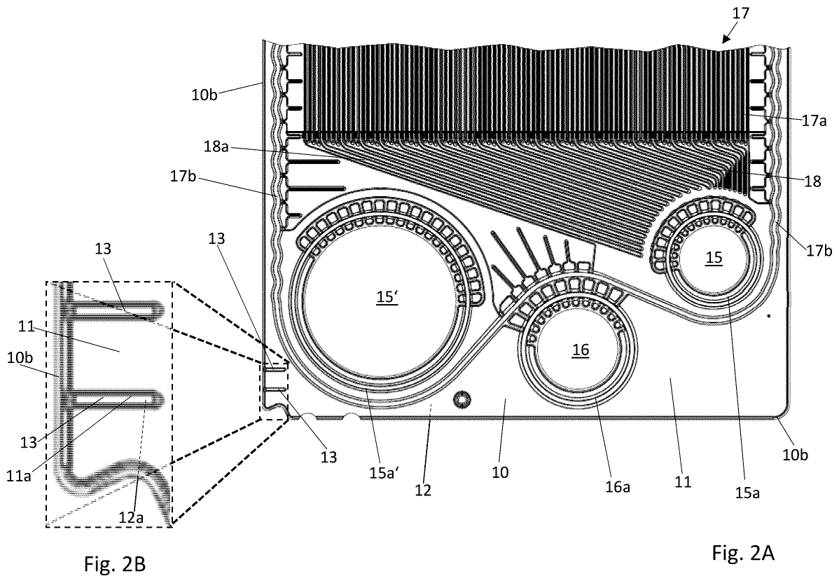

FIG. 2A shows, in a plan view, part of a separator plate 10 known from the prior art, wherein the separator plate 10 shown in FIG. 2A can be used, for example, in an electrochemical system of the same type as the system 1 from FIG. 1. The separator plate 10 comprises a first and a second individual plate 11, 12, which are connected in a materially bonded manner along the plate plane of the separator plate 10. Only the first individual plate 11 is visible in FIG. 2A; the second individual plate 12 is mainly hidden by the first individual plate 11. The first and the second individual plate 11, 12 may each be manufactured from a metal sheet, for example from a stainless steel sheet. The individual plates 11, 12 have through-openings, which are aligned with each other and form through-openings 15, 15′ and 16 of the separator plate 10. When a plurality of separator plates of the same type as the separator plate 10 are stacked, the through-openings 15, 15′ and 16 form lines which extend through the stack 1a in the stacking direction 1b (see FIG. 1). Typically, each of the lines formed by the through-openings 15, 15′, 16 is fluidically connected to one of the media ports 3a, 3b, 4a, 4b, 5a, 5b in the end plates 2a, 2b of the system 1. For example, the lines formed by the through-openings 15, 15′ serve to supply fuel and reaction gas to the electrochemical cells of the fuel cell stack 1a. In contrast, coolant can be introduced into the stack 1a or discharged from the stack 1a via the line formed by the through-opening 16.

In order to seal off the through-openings 15, 15′, 16 with respect to the interior of the stack 1a and with respect to the surrounding environment, the first individual plate 11 has beads 15a, 15a′, 16a, which are arranged in each case around the through-openings' beads 15, 15′, 16 and in each case completely surround the through-openings 15, 15′, 16. On the rear side of the separator plate 10, facing away from the viewer of FIG. 2A, the second individual plate 12 has corresponding beads for sealing off the through-openings 15, 15′, 16 (not shown).

In an electrochemically active region 17 of the separator plate 10, the first individual plate 11 has, on the front side thereof facing towards the viewer of FIG. 2A, a flow field with guide structures 17a for guiding a reaction medium along the front side of the separator plate 10. In FIG. 2A, these guide structures 17a are defined by a plurality of webs and by channels extending between the webs and delimited by the webs. Only part of the active region 17 on the front side of the separator plate 10 is shown in FIG. 2A. On the front side of the separator plate 10, facing towards the viewer of FIG. 2A, the first individual plate 11 additionally has a distribution or collection region 18. The distribution or collection region 18 comprises distribution structures 18a which are designed to distribute over the active region 17 a medium that is introduced from the through-opening 15 into the distribution or collection region 18 and/or to collect or to pool a medium flowing towards the through-opening 15 from the active region 17. In FIG. 2A, the distribution structures 18a of the distribution or collection region 18 are likewise defined by webs and by channels extending between the webs and delimited by the webs.

The first individual plate 11 additionally has a perimeter bead 17b, which surrounds the active region 17, the distribution or collection region 18 and the through-openings 15, 15′ and seals these off with respect to the through-opening 16, e.g. with respect to the coolant circuit, and with respect to the environment surrounding the system 1. A perimeter bead is therefore a sealing element in the same way as a bead referred to here as a sealing bead. The structures of the active region 17, the distribution structures of the distribution or collection region 18 and the beads 15a, 15a′, 16a and 17b are formed in one piece with the first individual plate 11 and are integrally formed in the first individual plate 11, for example by embossing.

With regard to guiding media from the through-openings 15, 15′ and 16 to the distribution and collection regions 18 and the active region 17 in the respective layers or on the respective surface of the separator plate 10 or the individual plates 11, 12, reference is made to DE 102 48 531 A1, DE 20 2015 104 972, DE 20 2015 104 973 and the as yet unpublished DE 20 2022 101 861.8, the content of each of said documents being fully incorporated in the present disclosure by way of reference.

The first and second individual plates 11, 12 of the separator plate 10 of FIG. 2A, which are arranged one above the other approximately in congruence, are approximately rectangular and have rounded corners. In one of the corners, here adjacent to the first through-opening 15′, two holding structures 13 for connector pins are arranged next to each other (see the detail view in FIG. 2B). The receptacles 13 are formed by a respective slot 11a and 12a in the first individual plate 11 and the second individual plate 12, said slots extending along the plate plane 10a in parallel, one above the other, from an outer edge 10b to an interior of the separator plate 10. A longitudinal direction of the slots 11a, 12a, and thus also a longitudinal direction of the holding structures 13, extends at an angle of 90° to the outer edge 10b. The slots 11a, 12a of the first and second individual plate 11, 12 also project out of the plate plane 10a of the separator plate 10 towards opposite sides, so that the slot 11a of the first individual plate 11 and the slot 12a of the second individual plate 12 together form an elongated holding structure 13 for a connector pin. A pin-shaped connector (connector pin) can be inserted into such a holding structure 13 and optionally secured by means of an additional locking element. One of the two holding structures 13 can be used to connect the separator plate 10 to a device for checking a cell voltage of the separator plate.

FIGS. 1 and 2 correspond to FIGS. 1 and 2 of the publication WO 2020/064975 A1, which is hereby fully incorporated in the present specification by way of reference.

When compressing a separator plate 10 according to the prior art which includes a MEA 6, it may happen in some cases that the MEA 6 is damaged by the embossed holding structures 13, for instance by the edge 10b of the separator plate 10 in the region of the holding structures 13. It may also happen that the MEA 6 is damaged during the insertion of the connector pin 31 into the holding structure 13. However, damage to the MEA 6 may lead to a short circuit or even to a total failure of the electrochemical system.

The present disclosure has been designed to solve or at least mitigate this problem. Various embodiments are shown in FIGS. 3 to 14.

A first embodiment of a separator plate 10 for an electrochemical system 1 having a separator plate plane 10a is shown in FIGS. 3A, 3B, 3C and 3D of figure group 3. The separator plate comprises a first individual plate 11 and a second individual plate 12, which are connected to each other and form at an outer edge 10b of the separator plate 10 a holding structure 13 for holding a connector pin 31.

The individual plates 11, 12 are spaced apart from each other in the region of the holding structure 13, so that the connector pin 31 can be inserted into the holding structure 13 along a direction of insertion. The holding structure 13 has a clamping region 30 and a receiving region 20. In the clamping region 30 the connector pin 31 can be clamped between the individual plates 11, 12. The receiving region 20 starts from the outer edge 10b and is arranged upstream of the clamping region 30 in the direction of insertion. The individual plates 11, 12 may come into contact with each other on both sides of the holding structure 13, for instance in the regions adjacent to the clamping region 30.

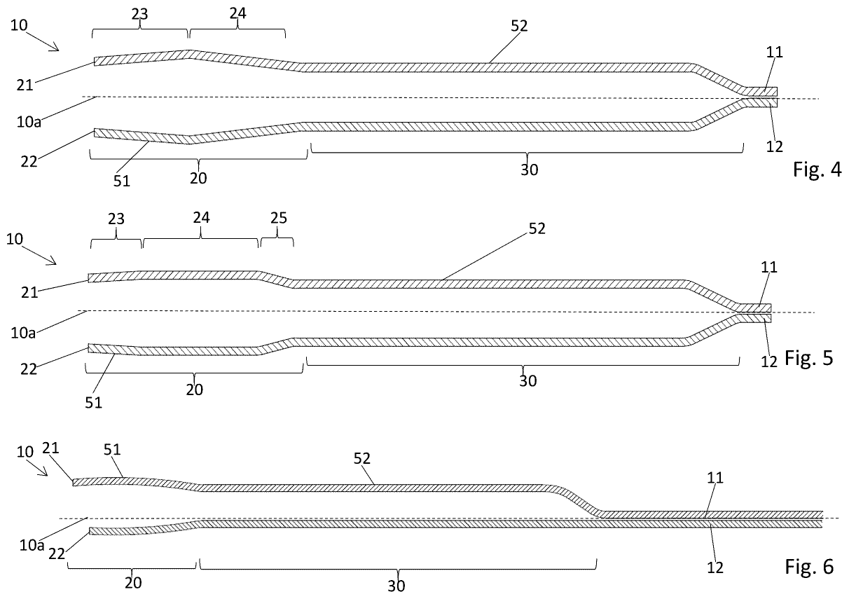

As can be seen in the sectional view of FIG. 3B, at least in a non-compressed state of the separator plate 10, the first individual plate 11 extends in a concave manner along the direction of insertion in the receiving region 20, so that an edge 21 of the first individual plate 11 is directed towards the separator plate plane 10a in the receiving region 20. The first individual plate may extend in an arcuate or angled manner in the receiving region 20. Various embodiments in respect of the concave design of the receiving region are shown in FIGS. 4, 5, 6, 7, 8 and 9 and will be described in detail below.

For example, in the first individual plate 11, the clamping region 30 may have a height of 0.3 mm, while the maximum height of the receiving region 13 is 0.4 mm. In the region of the edge 21, the height of the individual plate—relative to the separator plate plane 10a—is in this example 0.38 mm in the non-compressed state.

The described holding structure 13 having the clamping region 30 and the concavely outwardly curved receiving region 20 may reduce the risk of the MEA 6 being damaged by the edge 21 of the first individual plate 11 in the receiving region 20 when the separator plate 10 is compressed. Since the edge 21 is directed towards the separator plate plane 10a in the receiving region 20, the likelihood of the separator plate 10 being folded over, twisted, or deformed to be out of alignment in the region of the outer edge 10b during the compression can be reduced. Due to the concave design, the receiving region 20 also has a certain spring behavior, thereby reducing the pressure with which a surface of the receiving region 20, at a distance from the outer edge 10b, presses locally against the MEA 6 when the stack is compressed. Overall, therefore, the risk of damage to the MEA 6 by the described holding structure 13 is reduced.

FIG. 3B shows an embodiment in which, in a non-compressed state of the separator plate 10, the second individual plate 12 also extends in a concave manner along the direction of insertion in the receiving region 20, so that an edge 22 of the second individual plate 12 is directed towards the separator plate plane 10a in the receiving region 20. The concave course may be arcuate or angled. For instance, embodiments are possible in which the first individual plate 11 and the second individual plate 12 are designed identically in the region of the holding structure or are arranged symmetrically with respect to each other along the separator plate plane 10a.

It can be seen in FIG. 3B, and also in FIGS. 4 to 9, that the two individual plates 11, 12 may be spaced further apart from each other, in a direction perpendicular to the separator plate plane 10a, in the receiving region 20 than in the clamping region 30. This may facilitate insertion of a connector pin and may have an effect on the spring behavior of the separator plate 10 during the compression.

In the separator plate 10 of FIGS. 3A and 3D, it is clear that the receiving region 20 may be wider than the clamping region 30. A width direction may be defined perpendicular to the direction of insertion and parallel to the separator plate plane 10a, wherein a longitudinal direction may be defined parallel to the direction of insertion. For instance, a ratio between a maximum width of the receiving region 20 and a maximum width of the clamping region 30 may be greater than 1, greater than 1.5, or greater than 2. By virtue of the increased width in the receiving region 20 in combination with the concave curvature, the spring behavior of the holding structure 13 in the receiving region 20 can be adjusted in such a way that the MEA 6 remains largely undamaged following compression of the stack and insertion of the connector pin 31.

The receiving region 20 may have a transition portion 26 which adjoins the clamping region 30 and in which the receiving region 20 tapers, so that the receiving region 20 merges into the clamping region 30. The transition portion 26, in which the outline of the receiving region 20 of the first individual plate 11 tapers towards the separator plate plane 10a in an orthogonal projection, is shown in FIG. 3D.

As shown in the plan view of the separator plate 10 in FIG. 3D and in the oblique view of FIG. 3A, the receiving region 20 of the first individual plate 11 may have at least in part a substantially funnel-shaped outline in an orthogonal projection onto the separator plate plane 10a. Alternatively, a trapezoidal or other tapering outline is also possible. In the embodiment of FIGS. 3A, 3D, the clamping region 30 of the holding structure 13 may have at least in part a rectangular outline in an orthogonal projection of the first individual plate 11 onto the separator plate plane 10a, so that the clamping region 30 is longer than it is wide. A ratio between the maximum extent of the clamping region 30 in the direction of insertion and the maximum extent of the clamping region 30 in a direction perpendicular to the direction of insertion and parallel to the separator plate plane 10a may be greater than 1, greater than 2, or greater than 3. Typically, the direction of insertion extends perpendicular to a course of the outer edge 10b in the region of the holding structure 13.

FIGS. 3A and 3D also illustrate the dimensions that the receiving region 20 may assume. In the embodiment shown, a ratio between the maximum extent of the receiving region 20 in the direction of insertion and the maximum extent of the receiving region 20 in a direction perpendicular to the direction of insertion and parallel to the separator plate plane 10a is less than 1. In other words, the receiving region 20 is wider than it is long. In some embodiments, a ratio between the maximum extent of the receiving region 20 in the direction of insertion and the maximum extent of the receiving region 20 in a direction perpendicular to the direction of insertion and parallel to the separator plate plane 10a may be less than 0.8, or less than 0.5. Here, the maximum extent of the clamping region 30 in the direction of insertion is, for example, 8 mm. The maximum extent of the receiving region 20 in the direction of insertion may be, for example, 2 mm. In a direction perpendicular thereto, the maximum extent of the receiving region 20 may be 4 mm.

The design of a top 51 of the receiving region 20 can be illustrated in the perspective sectional view of FIG. 3C. The holding structure 13 has the top 51 in the receiving region 20, the top 51 being a delimitation of an interior of the holding structure 13 in a height direction perpendicular to the separator plate plane 10a. Surface lines 53 that extend perpendicular to the direction of insertion on the roof 51 may extend in a rectilinear manner and/or parallel to the separator plate plane 10a. The surface lines 53 are shown in FIG. 3C for better clarity.

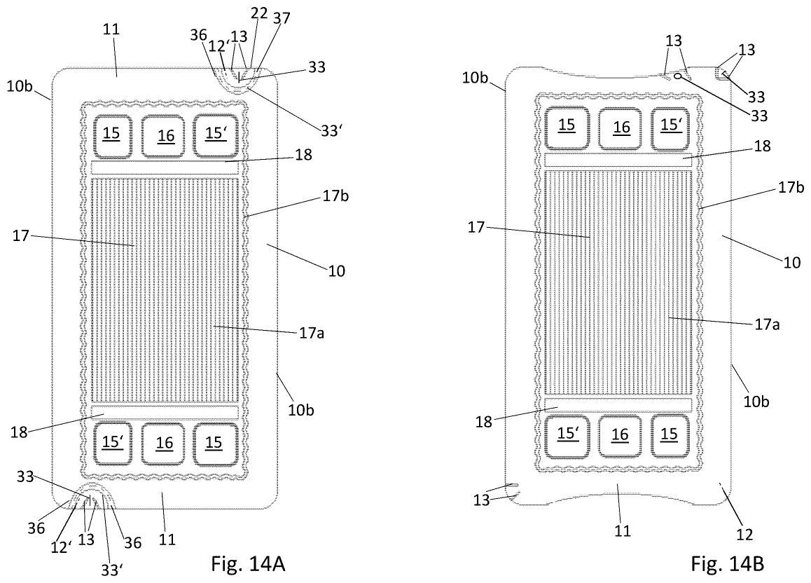

The individual plates 11, 12 of the separator plate 10 may form a further holding structure 13′ for holding a connector pin 31, cf. FIG. 3A. Embodiments are conceivable in which the individual plates 11, 12 form exactly one or, for example, exactly two holding structures 13, 13′. Also conceivable are embodiments in which the individual plates 11, 12 form at least two, or at least three or at least four holding structures 13, 13′, see also FIG. 12, where four holding structures 13, 13′, 13″, 13″ are shown by way of example. The directions of insertion of at least two holding structures 13, 13′ may often extend parallel to each other. Alternatively, an angle enclosed by the two directions of insertion may be up to 30° or up to 15°, as shown, for example, in FIGS. 14A and 14B.

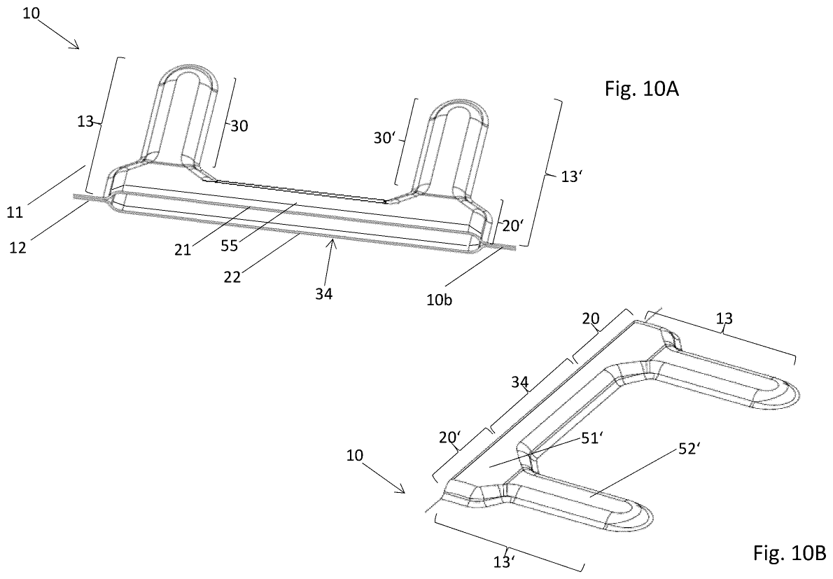

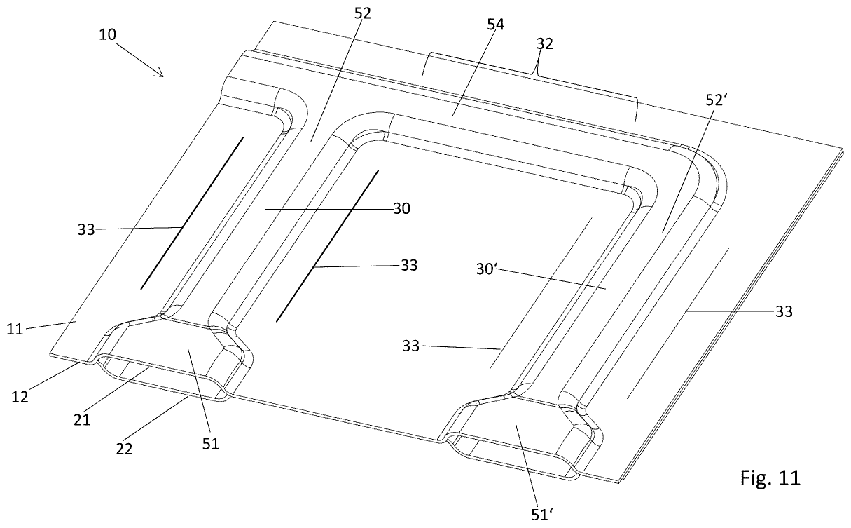

In embodiments with at least two holding structures 13, 13′, the separator plate 10 may have an embossed structure, for instance a supporting structure 32 and/or a connecting structure 34, which connects the at least two holding structures 13, 13′ to each other. FIGS. 10A, 10B and 11 show such embodiments of the separator plate 10. Although only a supporting structure 32 or a connecting structure 34 is shown in each of FIGS. 10A, 10B and 11, it is clear that embodiments are possible which have both a supporting structure 32 and a connecting structure 34.

FIGS. 10A and 10B show a perspective view of one such embodiment of the separator plate 10 with two holding structures 13, 13′, wherein the receiving regions 20, 20′ of the two holding structures 13, 13′ merge into each other by means of a connecting structure 34 along the outer edge 10b. Along the direction of insertion and in a front part, the connecting structure 34 may have the same partial course or the same shape as the receiving region 20, 20′ of the holding structures 13, 13′. The connecting structure 34 may have at least in part a top 55 as a region in which the connecting structure 34 extends parallel to the separator plate plane 10a. The connecting structure may also have a flank which starts from the plate plane 10a and in which the individual plate 11, 12 moves further away from the separator plate plane 10b. In the region of the connecting structure, as in the receiving region 20, 20′, the edges of the individual plates 11, 12 are directed towards the plate plane 10b. The design of the connecting structure 34 may, for example, influence the spring effect of the receiving region 20, 20′.

FIG. 11 shows an embodiment in which the separator plate has a supporting structure 32, wherein the clamping regions 30, 30′ of at least two holding structures 13, 13′ are connected to each other at a distance from the outer edge 10b by way of the supporting structure 32. The supporting structure 32 is designed as a full bead which extends between the clamping regions 30, 30′ and extends parallel to the outer edge 10b. The supporting structure 32 connects the two ends of the clamping regions 30, 30′ to each other. The supporting structure 32 may have a top 54 which is located at the same distance from the separator plate plane 10a as the top 52 of the clamping region 30. Embodiments are also possible in which the top 54 of the supporting structure 32 is located at a greater or smaller distance from the separator plate plane 10a than the top 52 of the clamping region 30. The supporting structure 32 may serve as a bearing surface for the MEA 6 and may locally support the MEA 6.

The two individual plates 11, 12 may be connected to each other by way of welded joints 33, cf. for example FIG. 11. Such joints between the two individual plates 11, 12 may, for example, prevent the two individual plates 11, 12 from moving apart. In this embodiment, the welded joints 33 are arranged for example at a distance from each other and in parallel on both sides of the clamping regions 30, 30′.

Examples of different courses of the receiving region 20 along the direction of insertion will be described below. FIGS. 3B, 4 and 5 show angled courses of the receiving region 20, and FIGS. 6, 7 and 8—as well as FIG. 9 for the first individual plate 11—show arcuate courses of the receiving region 20.

FIGS. 3B, 4 and 5 each show a sectional view of the holding structure 13. The section plane is perpendicular to the separator plate plane 10a and extends parallel to the direction of insertion of the first holding structure 13. The course of the section plane of FIG. 3B is indicated in FIG. 3A by the line A-A. In the sectional views, it is clear that the individual plates 11, 12 are spaced further apart from each other, in a direction perpendicular to the separator plate plane 10a, in the receiving region 20 than in the clamping region 30. In addition, the illustrations show that, in a non-compressed state of the separator plate 10, the first individual plate 11 extends in a concave manner along the direction of insertion in the receiving region 20, so that an edge 21 of the first individual plate 11 is directed towards the separator plate plane 10a in the receiving region 20. In the embodiment shown, the second individual plate 12 also extends in a concave manner along the direction of insertion in the receiving region 30, so that the edge 22 thereof is directed towards the separator plate plane 10a in the receiving region 20.

The receiving region 20 of the exemplary embodiment of FIG. 3B or FIG. 5 can be divided into three portions 23, 24, 25 along the direction of insertion. The individual plates 11, 12 are straight in the respective portions 23, 24, 25 and are connected to each other at an angle. In a first portion 23, which starts from the edge 21, 22, the individual plates 11, 12 move further away from the separator plate plane 10a as the distance from the edge 21, 22 increases. In a second portion 24, which adjoins the first portion 23, the individual plates 11, 12 extend parallel to the separator plate plane 10a, and in a subsequent third portion 25 the individual plates move closer to the separator plate plane 10a again until they merge into the clamping region 30. The edge 21, 22 is often located at a greater distance from the separator plate plane than the point at which the third portion merges into the clamping region 30. The first portion 23 may be longer in the direction of insertion than the third portion 25. The second portion 24 may be longer in the direction of insertion than the first portion 23 and the third portion 25. The first portion 23 and the third portion 25 may have different gradients. For example, in FIG. 5, the first portion 23 has a much shallower course than the third portion 25. Embodiments are also possible in which the second portion does not extend parallel to the separator plate plane 10a.

FIG. 4 shows a sectional view of a further embodiment of a separator plate. The receiving region 20 in the exemplary embodiment of FIG. 4 can be divided along the direction of insertion into two portions 23 and 24, which are substantially rectilinear and are connected to each other at an angle. In contrast to FIGS. 3B and 5, here there is no middle portion, which in FIGS. 3B and 5 is formed for example parallel to the separator plate plane 10a. In the first portion 23, which starts from the edge 21, 22, the individual plates 11, 12 move further away from the separator plate plane 10a as the distance from the edge 21, 22 increases. In the subsequent second portion 24, the individual plates move closer to the separator plate plane 10a again until they merge into the clamping region 30. The edge 21, 22 may be located at a greater distance from the separator plate plane 10a than the point at which the second portion 24 merges into the clamping region 30.

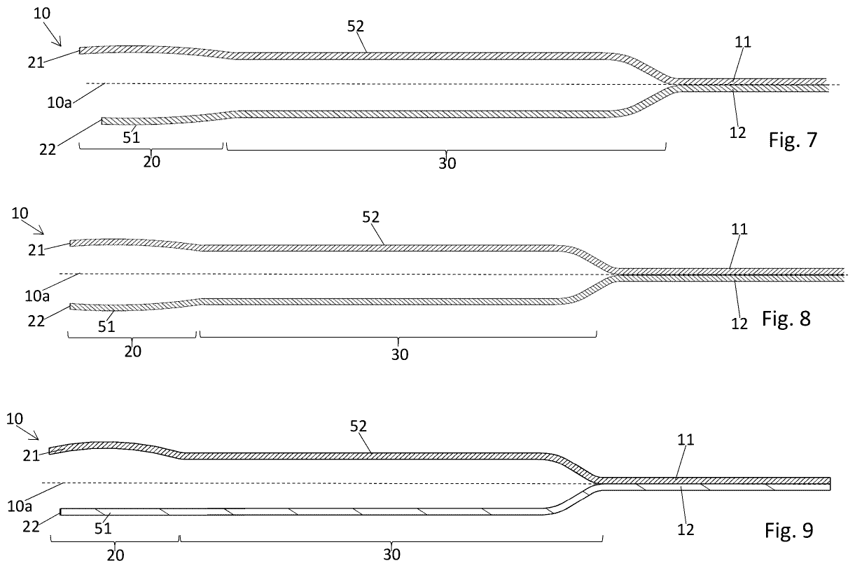

FIGS. 6, 7 and 8 each show a sectional view of an embodiment of the separator plate 10 in which the individual plates 11, 12 are arcuate in the receiving region 20. The two individual plates 11, 12 may be designed differently in the region of the holding structure 13, cf. FIGS. 6 and 7, or may be designed identically or symmetrically, cf. FIG. 8. The section plane is perpendicular to the separator plate plane 10a and extends parallel to the direction of insertion of a holding structure 13. In the clamping region 30 of the separator plate in the embodiment shown in FIG. 6, the first individual plate 11 is spaced apart from the separator plate plane 10a, while the second individual plate 12 extends along the separator plate plane 10a. The first individual plate 11 has in the clamping region 30 an area that extends parallel to the separator plate plane 10a in the direction of insertion.

It is also clear from FIGS. 6-8 that the edges 21, 22 of the two individual plates are located at a distance from the separator plate plane 10a. Starting from the edge 21, 22, the individual plates 11, 12 initially move further away from the separator plate plane 10a. They then move closer to the separator plate plane 10a again, so that a transition to the clamping region 30 is achieved. In FIG. 9, the edges 21 and 22 are again spaced apart, but the rest of the course, at least in the second individual plate 12, differs from that in FIGS. 6-8.

In FIG. 6, the edge 21 of the first individual plate 11 is located further away from the separator plate plane 10a than the edge 22 of the second individual plate 12. The edge 21 of the first individual plate 11 is also located further away from the separator plate plane 10a than the area of the clamping region 30 of the first individual plate 11 that is formed parallel to the separator plate plane 10a. The edge 22 of the second individual plate 12 is set back in comparison to the edge 21 of the first individual plate 11, which means that the first individual plate 11 extends further in the longitudinal direction, e.g. in the direction of insertion, than the second individual plate 12.

In the clamping region 30 of the separator plate in the embodiment shown in FIG. 7, both individual plates 11, 12 are located at a distance from the separator plate plane 10a. Both individual plates 11, 12 have in the clamping region 30 an area that extends parallel to the separator plate plane 10a in the direction of insertion. The individual plates 11, 12 are located at equal distances from the separator plate plane 10a in this parallel area.

In FIG. 7, both edges 21, 22 are located further away from the separator plate plane 10a than the areas of the clamping region 30 of the respective individual plates 11, 12 that are formed parallel to the separator plate plane 10a. The edge 21 of the first separator plate 11 is located at a smaller distance from the separator plate plane 10a than the edge 22 of the second separator plate 12. The edge 22 of the second individual plate 12 is set back in comparison to the edge 21 of the first individual plate 11.

FIG. 8 shows a sectional view of an embodiment of the separator plate in which, in the region of the holding structure, the two individual plates 11, 12 are formed identically or symmetrically along the separator plate plane 10a. Both individual plates 11, 12 have in the clamping region 30 an area that extends parallel to the separator plate plane 10a in the direction of insertion. In this parallel area, the individual plates 11, 12 are located at an equal distance from the separator plate plane 10a. In the receiving region 20, both individual plates have the same, mirror-image, arcuate course along the direction of insertion.

FIG. 9 shows a sectional view of an embodiment of the separator plate in which only the upper individual plate 11 has an arcuate course towards the edge 21, while the lower individual plate 12, although forming a clamping region 30 like the first individual plate 11, continues to extend in a planar manner towards its edge 22.

The features of the above-described courses of the holding structures 13 can be combined with each other in further embodiments. For example, embodiments are possible in which the first individual plate 11 has an arcuate receiving region 20 and the second individual plate 12 has an angled receiving region 20. Furthermore, embodiments are possible in which the first portion 23, the second portion 24 or the third portion 25 are arcuate and may merge into each other at an angle, so that the receiving region 20 extends for example in part in an arcuate manner and in part in a rectilinear or angled manner. In addition, embodiments with more than three portions 23, 24, 25 of the concave curvature are possible.

FIG. 12 shows a sectional view of an assembly for an electrochemical system, comprising a separator plate 10 and a membrane electrode assembly 6 (MEA) which is arranged parallel to the separator plate plane 10a of the separator plate 10. The MEA 6 comes into contact with the separator plate 10 at the receiving region 20, wherein the edge 21 of the first individual plate 11 and the edge 22 of the second individual plate 12 are spaced apart from the MEA 6 in the region of the holding structure 13 in a compressed state of the assembly. The section plane extends through the receiving region 20 and parallel to the outer edge 10b of the separator plate 10, for example along the dashed line shown in FIG. 3D. FIG. 12 shows a plurality of such assemblies, which are compressed to form a stack.

Each separator plate 10 has four holding structures 13, 13′, 13″, 13″, which are arranged one above the other in a direction of compression, as a direction perpendicular to the separator plate planes 10a. Of the holding structures 13, only the associated receiving regions 20, 20′, 20″, 20′ are visible in the sectional view. Connector pins 31 are clamped in the clamping region 30 of some holding structures 13. The connector pins 31 have a round cross-section and in the embodiment shown do not come into contact with the separator plate 10 in the receiving region 20, 20′, 20″, 20′″. Other cross-sections of the connector pins 31 are also possible as an alternative, cf. what has been stated above. Overall, a plurality of connector pins 31 are inserted into the assembly, with one connector pin 31 always being located in one of the illustrated separator plates 10 of the assembly. The connector pins 31 are arranged offset from each other in the assembly.

FIG. 13 shows a sectional view of a further embodiment of an assembly for an electrochemical system 1, similar to that in FIG. 12. In the illustrated embodiment of the separator plates 10, only one of the individual plates 11 is concave in the receiving region 20. Instead of a single continuous second individual plate 12, the separator plate 10 in this case has a plurality of second individual plates 12′, but these extend substantially only in the region of the holding structure 13. Each of the plurality of second individual plates 12′ can form at least one holding structure 13 with the first individual plate 11. Such embodiments may occur when a separator plate only has to guide two media and does not require any media guidance in an interior. The first individual plate 11 often has a stepped embossment 36, which makes it possible to receive a second individual plate 12′ without forming a significant height step on the underside of the separator plate 10. Along the step 36 and along the edge of the second individual plates 12′, the first individual plate 11 and the second individual plates 12′ are at least in part welded to each other (cf. also FIG. 14A). Also in FIG. 13, as in FIG. 12a, a connector pin 31 is inserted into a holding structure 13 of each separator plate 10 and is clamped in the clamping region 30, without the MEA 6 being damaged by the outer edge 10b of the separator plates 10 or being damaged during the insertion of the connector pin 31.

FIGS. 14A and 14B show, by way of example, in two schematic plan views, the locations at which the holding structures 13 according to the present disclosure may be located on a separator plate 10.

FIG. 14A shows an example in which a group of two holding structures 13 is formed on each of the two short edges of the separator plate 10. These groups may be converted into each other by point reflection. The groups of holding structures 13 are designed similarly to those in FIG. 13, each being delimited by the same full-surface first individual plate 11 and a second individual plate 12′ that extends only over a small portion of the area of the separator plate 10, said second individual plate being received in a stepped depression 36 of the first individual plate 11. In the receiving region 20 and in the clamping region 30 of the holding structures 13, structures are embossed into the first individual plate 11. In contrast to the previous exemplary embodiments, the holding structures 13 located closest to each other do not extend parallel to each other, but instead extend at an angle of approximately 60° to the outer edge, e.g. in a manner deviating 30° from the perpendicular, and at an angle of approximately 60° to each other. A welded joint 33 is provided between the holding structures 13 of a group. The first individual plate 11 and the second individual plates 12′ are connected by means of welded joints 33′ at the edge 37 of the second individual plates 12′.

FIG. 14A thus shows a separator plate 10 in which only the first individual plate 11 has, on both surfaces, e.g. on its upper side and underside, a guide structure 17a for guiding reaction medium. Each area of two groups of holding structures 13 has a second individual plate 12′. The separator plate 10 thus comprises two second individual plates 12′ in total. Each of the two second individual plates 12′ forms two holding structures 13 with the first individual plate 11. An embodiment with a full-surface first individual plate 11 and second individual plates 12′ that extend only in the area of the holding structures may occur, for example, when media guidance is required only on two planes, e.g. for example on both surfaces of the first individual plate 11.

FIG. 14B shows a separator plate 10 in which the individual plates 11, 12 each have, on both surfaces, a guide structure 17a for guiding the reaction medium and/or coolant, and the individual plates 11, 12 have substantially the same surface area.

FIG. 14B shows a separator plate 10 in which, by way of example, three groups of holding structures 13 are integrally formed. The three groups are here shown in one plate. Each of these groups may however also be used as the only group of holding structures in one plate. In the lower region of the left side edge of the separator plate 10, the upper holding structure 13 of such a group still extends in the rectilinear portion of the side edge, and specifically perpendicular thereto. In contrast, the lower holding structure of this group extends perpendicular to a curved outer edge portion and thus at an angle of approximately 50° to the first holding structure.

In the top right corner, two holding structures 13 each extend perpendicular to the curved outer edge. Due to the significant curvature of the outer edge, the two holding structures 13 extend perpendicular to each other. To prevent any gaping between the two holding structures 13 of the group of holding structures, the individual plates 11, 12 are connected by a welded joint 33.

In the inwardly curved upper outer edge portion, two further holding structures 13 are provided, between which the individual layers 11, 12 are connected to each other by an annularly closed welded joint 33. While the holding structure 13 on the right extends substantially perpendicular to the curved outer edge, the holding structure 13 on the left encloses an angle of less than 90° with the outer edge.

FIGS. 1-14B are shown approximately to scale. FIGS. 1-14B show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” or “substantially” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A separator plate for an electrochemical system, the separator plate comprising:
a separator plate plane,
a first individual plate and a second individual plate which are connected to each other and form at an outer edge of the separator plate, and
a holding structure for holding a connector pin,
wherein the individual plates are spaced apart from each other in the region of the holding structure, so that the connector pin can be inserted into the holding structure along a direction of insertion,
wherein the holding structure has a clamping region and a receiving region,
wherein in the clamping region the connector pin can be clamped between the individual plates,
wherein the receiving region starts from the outer edge and is arranged upstream of the clamping region in the direction of insertion, and
wherein at least in a non-compressed state of the separator plate, at least the first individual plate extends in a concave manner along the direction of insertion in the receiving region, so that an edge of the first individual plate is directed towards the separator plate plane in the receiving region.

2. The separator plate according to claim 1, wherein, at least in a non-compressed state of the separator plate, the second individual plate extends in a concave manner along the direction of insertion in the receiving region so that an edge of the second individual plate is directed towards the separator plate plane in the receiving region.

3. The separator plate according to claim 1, wherein the individual plates are spaced further apart from each other, in a direction perpendicular to the separator plate plane, in the receiving region than in the clamping region.

4. The separator plate according to claim 1, wherein a ratio between a maximum width of the receiving region and a maximum width of the clamping region is greater than 1, wherein a width direction is defined perpendicular to the direction of insertion and parallel to the separator plate plane.

5. The separator plate according to claim 4, wherein the receiving region has a transition portion which adjoins the clamping region and in which the receiving region tapers, so that the receiving region merges into the clamping region.

6. The separator plate according to claim 1, wherein, in an orthogonal projection of the first individual plate onto the separator plate plane, the receiving region has at least in part a substantially funnel-shaped or trapezoidal outline.

7. The separator plate according to claim 1, wherein, in an orthogonal projection of the first individual plate onto the separator plate plane, the clamping region has at least in part a substantially rectangular outline.

8. The separator plate according to claim 1, wherein the direction of insertion extends substantially perpendicular to a course of the outer edge in the region of the holding structure.

9. The separator plate according to claim 1, wherein a ratio between the maximum extent of the clamping region in the direction of insertion and the maximum extent of the clamping region in a direction perpendicular to the direction of insertion and parallel to the separator plate plane is greater than 1.

10. The separator plate according to claim 1, wherein a ratio between the maximum extent of the receiving region in the direction of insertion and the maximum extent of the receiving region in a direction perpendicular to the direction of insertion and parallel to the separator plate plane is less than 1.

11. The separator plate according to claim 1, wherein the holding structure has a top in the receiving region, wherein surface lines that extend perpendicular to the direction of insertion on the top extend in a rectilinear manner and/or parallel to the separator plate plane.

12. The separator plate according to claim 1, wherein the individual plates come into contact with each other on both sides of the holding structure and along the outer edge.

13. The separator plate according to claim 1, wherein the individual plates form at least one further holding structure for holding a connector pin.

14. The separator plate according to claim 13, further having an embossed structure which connects at least two holding structures to each other.

15. The separator plate according to claim 13, wherein the directions of insertion of at least two holding structures extend parallel to each other.

16. The separator plate according to claim 13, wherein the receiving regions of at least two holding structures merge into each other at a connecting structure along the outer edge.

17. The separator plate according to claim 13, wherein the clamping regions of at least two holding structures are connected to each other at a distance from the outer edge by a supporting structure.

18. The separator plate according to claim 1, wherein the individual plates each have, on both surfaces, a guide structure for guiding reaction medium and/or coolant, and the individual plates have substantially the same surface area.

19. The separator plate according to claim 1, wherein the first individual plate has, on both surfaces, a guide structure for guiding reaction medium, and at least or only the region of a holding structure has at least a second individual plate.

20. An assembly for an electrochemical system, comprising a separator plate according to claim 1 and a membrane electrode assembly (MEA) which is arranged parallel to the separator plate plane of the separator plate,
wherein the MEA comes into contact with the separator plate in the region of the holding structure,
wherein the edge of the first individual plate and the edge of the second individual plate are spaced apart from the MEA in the region of the holding structure in a compressed state of the assembly.
